(19) United States
(12) Patent Application Publication
(10) Pub. No.: US 2024/0213908 A1
(43) Pub. Date: Jun. 27, 2024

(54) PROJECT TYPE SOLAR WINDOW SYSTEM WITH FALL PROTECTOR

(71) Applicant: SUNFLEUR ENERGY SOLUTION CO., LTD., Suwon-si Gyeonggi-do (KR)

(72) Inventor: Chun Hwan NAM, Daegu (KR)

(21) Appl. No.: 17/918,416

(22) PCT Filed: Dec. 16, 2021
(86) PCT No.: PCT/KR2021/019153

§ 371 Date: Oct. 12, 2022

(30) Foreign Application Priority Data
Jun. 16, 2021 (KR) 10-2021-0077996

(51) Int. Cl. H02S 20/26; E05D 15/44; E06B 3/38; E06B 5/00; E06B 7/09; H02S 20/30

(52) U.S. Cl. CPC H02S 20/26; E05D 15/44; E06B 3/38; E06B 5/00; E06B 7/09; H02S 20/30

(57) ABSTRACT

Embodiments of the present invention relates to a window system with improved safety in a structure in which a solar panel is projected and tilted, and more particularly, a project type solar window system with fall protector according to present invention includes a window frame; a project frame with an upper end hinged to an upper end of the window frame configured to be opened and closed in a project type with respect to the window frame; a solar panel provided inside the project frame; a project cylinder installed between the window frame and the project frame that allows the project frame to be opened and closed in a project type with respect to the window frame; a tilt cylinder installed on the project frame that allows the solar panel to be opened and closed by tilting with respect to the project frame; and a fall protecting chassis installed at rear end of the window frame.

### TECHNICAL FIELD

The present invention relates to a window that opens and closes in a project type, and more particularly, to a window system with improved safety in a structure in which a solar panel is projected and tilted.

### BACKGROUND ART

As greenhouse gas reduction becomes a major issue in countries around the world, methods to reduce greenhouse gas are emerging one after another. One of these measures is to install a solar panel in a building or install a solar panel in a part of the building in order to reduce the use of fossil energy. The solar panels may be broadly divided into BAPV (Building Applied PhotoVoltaic) system or BIPV (Building Integrated PhotoVoltaic) system.

However, there is a problem in that it has to be customized according to the installation environment because the BIPV system has to act as a construction material for a building while performing a power generation function. In addition, even if the BIPV system was installed, there is a problem in that the power generation efficiency is low due to the influence of the incident angle of sunlight, shade, and the like.

In order to solve this problem, the present inventor has invented a window for photovoltaic power generation system (KR 10-1922890) that can be affected as little as possible by the incident angle of sunlight or shade by tilting the solar panel while the window is opened and closed in a project type.

FIG. 1 shows a conventional BIPV system in a project opening and closing type, the conventional BIPV system in a project opening and closing type includes a first frame 1 installed on the exterior window frame of a building, a second frame 3 coupled to the first frame 1, and a photovoltaic module 5 which is composed of a plurality of solar panels and installed in the inner side of the second frame 3. And, the second frame 3 performs to open and close in the project type, and power generation efficiency is maximized by tilt of the solar panel in the photovoltaic module 5.

However, in the case of the conventional solar panel, the size of the photovoltaic cells constituting the solar panel is about 16 cm in width and length, so the height of the photovoltaic module 5 corresponds to about 20 cm. Therefore, when the photovoltaic module 5 is fully opened by tilting, a space S1 with a width of about 18 cm is formed. For infants around 1 year old who are crawling or just starting to walk, the head diameter is around 15 cm, so there is a problem that the head of infants may be caught between the photovoltaic modules 5. (Recently, in the case of apartments, there are many cases of balcony extensions, so the probability of such an accident is higher because the conventional BIPV system in a project opening and closing type is installed directly on the wall of the living room). In particular, when the projecting second frame 3 is maximally open, the width of the space S2 between the lower end of the first frame 1 and the lower end of the second frame 3 is about 30 to 40 cm, so that an accident that a child or even an adult is fallen may occur.

### DETAILED DESCRIPTION OF THE INVENTION

### Technical Problem

The present invention has been invented to solve the above problems, and the subject matter to be solved by the present invention is to provide a project type solar window system without the possibility of falling or jamming even if the window is opened by a project or tilt.

### Technical Solution

Project type solar window system provided with a fall protector according to the present invention may include a window frame; a project frame that an upper end is hinged to the upper end of the window frame and the a lower end is opened and closed in a project type while moving away from or closer to the window frame; a solar panel provided inside the project frame; a project cylinder installed between the window frame and the project frame and that allows the project frame to be opened and closed in the project type with respect to the window frame; a tilt cylinder installed in the project frame and that allows the solar panel to be tilt-opened and tilt-closed with respect to the project frame, and a fall protecting chassis installed at rear end of the window frame.

### Advantageous Effects

The project type solar window system with a fall protector according to the present invention may prevent safety accidents such as falls or jamming by making the width of the fall protecting chassis smaller than the width of the solar panel.

In addition, the present invention may improve the solar power generation efficiency since the solar panel may be rotated in the azimuth direction.

### BRIEF DESCRIPTION OF DRAWINGS

FIG. 1 shows a conventional BIPV system in a project opening and closing type.

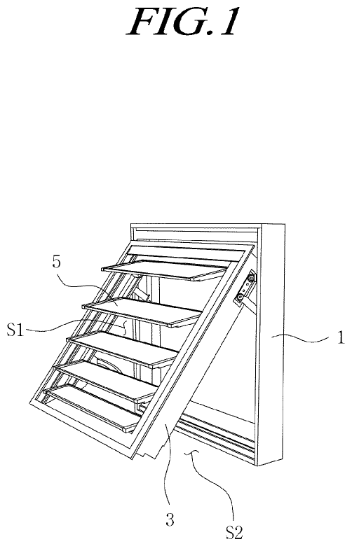

FIG. 2 is a perspective view of a project type solar window system provided with a fall protector according to the present invention.

FIG. 3 is an exploded perspective view of a project type solar window system with a fall protector according to the present invention.

FIG. 4 is an operating state diagram from the side of a project type solar window system with a fall protector according to the present invention.

FIG. 5 is an operating state diagram of another embodiment of a project type solar window system with a fall protector according to the present invention.

FIG. 6 is an exploded perspective view of part A of FIG. 5.

FIG. 7 is a schematic diagram showing an entire form of wire in the present invention.

FIG. 8 is an exploded perspective view of part B of FIG. 5.

FIG. 9 shows a lower portion of the project frame rotated in the azimuth direction.

FIG. 10 is an operating state diagram of another embodiment of a project type solar window system with a fall protector according to the present invention.

### MODE FOR CARRYING OUT THE INVENTION

Hereinafter, a project type solar window system with a fall protector according to the present invention will be described in detail with reference to the accompanying drawings.

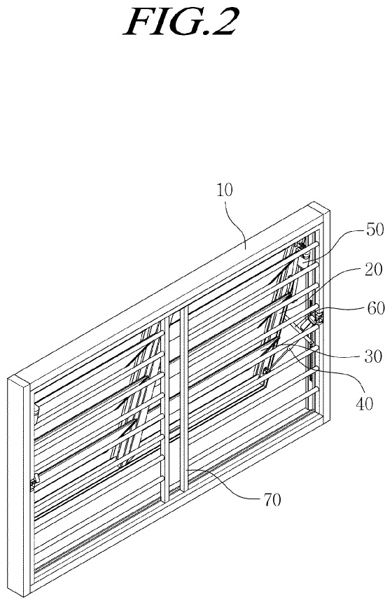

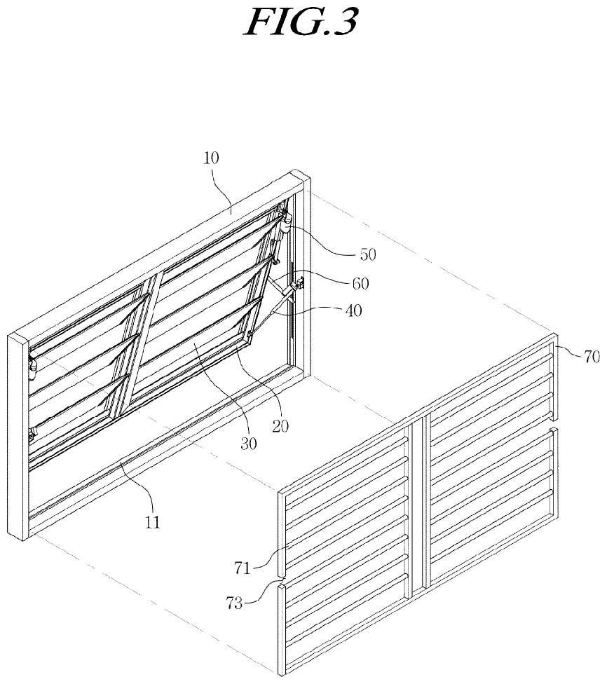

FIG. 2 is a perspective view of a project type solar window system provided with a fall protector according to the present invention and FIG. 3 is an exploded perspective view of a project type solar window system with a fall protector according to the present invention. The project type solar window system with a fall protector according to the present invention may include a window frame 10, a project frame 20 configured to be opened and closed in a project type with respect to the window frame 10, a solar panel 30 configured to tilt to the project frame 20, a project cylinder 40 configured to open and close the project frame 20 in a project type with respect to the window frame 10, a tilt cylinder 50 configured to tilt the solar panel, and a fall protecting chassis 60, and may further include a support 70 configured to prevent shaking of the project frame 20.

The window frame 10 is a component that allows the project type solar window system with a fall protector according to the present invention serves as a window by being installed in a building to form the outermost part of the project type solar window system with a fall protector according to the present invention. A threshold 11 protruding to the inside of the window frame 10 is configured to enable to block water and air from outside when the project frame 20 is closed.

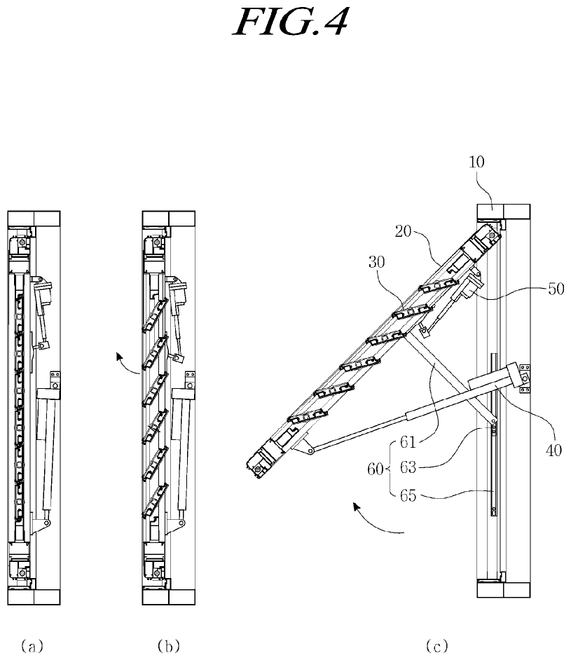

FIG. 4 is an operating state diagram from the side of a project type solar window system with a fall protector according to the present invention. The project frame 20 is opened and closed in a project type due to an upper end hinged to the upper end of the window frame 10 and a lower end configured to move away or close to the window frame 10. Moreover, the solar panel 30 provided in the project frame 30 is tilted to increase the solar power generation efficiency or to widen the external view.

The solar panel 30 is composed of a solar cell and a solar cell frame supporting the solar cell.

The project cylinder 40 is a component installed between the window frame 10 and the project frame 20 that allows the project frame 20 to be opened and closed in a project type with respect to the window frame 10. The tilt cylinder 50 is a component installed on the project frame 20 that allows the solar panel 30 to be opened and closed by tilting with respect to the project frame 20.

The fall protecting chassis 60 is a component installed at rear end of the window frame 10, that is inside a building when the project type solar window system with a fall protector according to the present invention is installed in the building, and includes a plurality of horizontal fall protecting ribs 61. The distance between the plurality of fall protecting ribs 61 is preferably 10 cm or less, because even a newborn infant has a head diameter of more than 10 cm and even if an object falls, the probability of a major accident is reduced when the object is less than 10 cm.

The fall protecting rib 61 may be installed vertically, but it is preferable to be installed horizontally. This is because there is no major problem in securing safety although vertically installed, but when vertically installed, a cross pattern formed with the horizontally installed solar panel 30 causes glimmer to human eyes. It is preferable that the installation position of the fall protecting rib 61 is horizontal (at the same height) as the tilt axis of the solar panel 30. It is because, a view cannot be secured on the tilt axis even if the solar panel 30 is completely opened and the project type solar window system with the fall protector according to the present invention can secure as much as possible by overlapping the fall protecting rib 61 on the part where the view cannot be secured. (This perspective assumes that only the solar panel 30 is opened while the project frame 20 is closed when securing an outside view, but it is true even in other cases. When the project frame 20 is opened, the view becomes narrow because the positions of the tilt axis of the solar panel 30 and the fall protecting rib 61 are misaligned. However, this problem occurs even when the installed position of the fall protecting rib 61 does not overlap the tilt axis of the solar panel 30 if the project frame 20 is closed. Therefore, there is no disadvantage in securing the view at least).

It is preferable that an accepting hole 63 configured to accept the project cylinder 40 is formed in the leftmost and rightmost side fall protecting ribs 61 of the fall protecting chassis 60. In order to reduce the thickness of the project type solar window system with fall protector according to the present invention, the project cylinder 40 should be positioned at the rear of the system as much as possible. Since the fall protecting chassis 60 is installed at the rear end of the window frame 10, the accepting hole 63 is required so that the project cylinder 40 does not interfere with the fall protecting chassis 60.

The support 70 is a component configured to prevent the project frame 20 from shaking when the project frame 20 is spaced away from the window frame 10 because of a large size of the project type solar window system with fall protector according to the present invention. It includes a supporting rib 71 which one end is rotatably connected to the project frame 20, a slide bar 73 which is rotatably connected to the other end of the supporting rib 71, and a guide slit 75 formed in the window frame 10 for guiding the slide bar 73.

The project type solar window system with fall protector according to the present invention may increase stability depending on a position of the guide slit 75. For example, the project frame 20 may be excessively opened with respect to the window frame 10 when a cylinder function of the project cylinder 40 is lost by damage or a combination of the project cylinder 40 with the window frame 10 or the project frame 20 is destroyed. In this case, if the upper end of the guide slit 75 is lower than a predetermined height, the opening of the project frame 20 may be limited since a rising position of the slide bar 73 is limited to less than the predetermined height. Appropriate specifications of the support 70 determined by the present inventors are that the length of the supporting rib 71 is ¼ to ⅓ of the height of the project frame 20, a position that the supporting rib 71 is rotatably coupled to the project frame 20 is 0.5 to 0.7 of the height of the project frame 20, and a position of the upper end of the guide slit 75 is 0.5 or less of the height of the window frame 10.

The project type solar window system with fall protector according to the present invention may be more free in the degree of opening of the window because it includes a fall protecting chassis 60. The photovoltaic power generation efficiency is affected not only by the sun's south-middle altitude, but also by the azimuth in the east-west direction. That is, energy efficiency may be increased by adjusting the azimuth angle of the solar panel 30 in the east-west direction. Therefore, if there is a fall protecting chassis 60, since it may not be affected by the opening by changing the azimuth of the solar panel 30, so it is possible to form a structure that may change the azimuth of the solar panel 30.

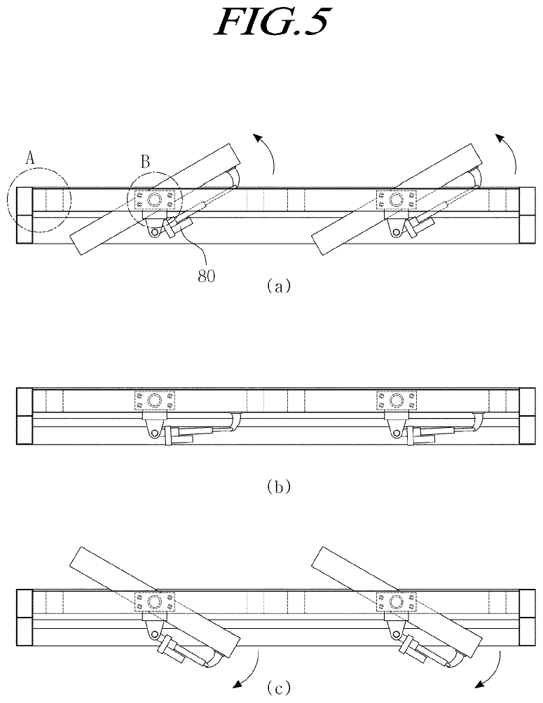

FIG. 5 is an operating state diagram of another embodiment of a project type solar window system with a fall protector according to the present invention. The project type solar window system with fall protector according to the present invention may be configured so that the solar panel 30 can be rotated in an azimuth direction with respect to a vertical axis. That is, as the sun moves from east to west, the solar power generation efficiency can be increased by allowing the orthogonal direction of the solar panel 30 to follow the sun. To this end, an azimuth control cylinder 80 for adjusting the azimuth angle of the solar panel 30 is provided.

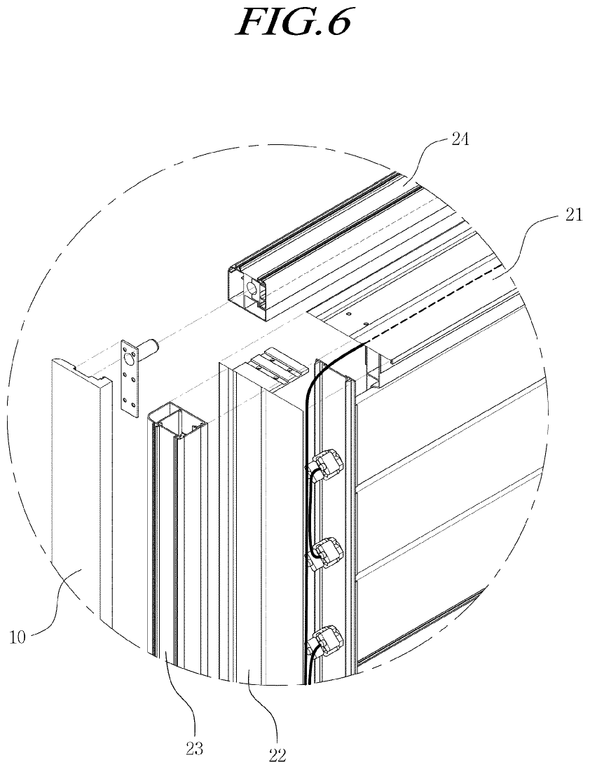

FIG. 6 is an exploded perspective view of part A of FIG. 5. The project frame 20 includes an upper cover 21, a first side cover 22, a lower cover (not shown), a second side cover 23 which is opened and closed in a project type in the outside of the first side cover 22, and a hinge bar 24 coupled on the upper cover 21 to enable the second side cover 23 to rotate in a project type that form a quadrangular frame to embed the solar panel 30 inside. And, an electric wire coupled to the solar panel 30 is connected to an external inverter or battery through the hinge bar 24 via the inside of the upper cover 21 and the first side cover 22. That is, the project opening and closing of the project frame 20 is made by the first side cover 22, and a change of the azimuth direction is made by the second side cover 23.

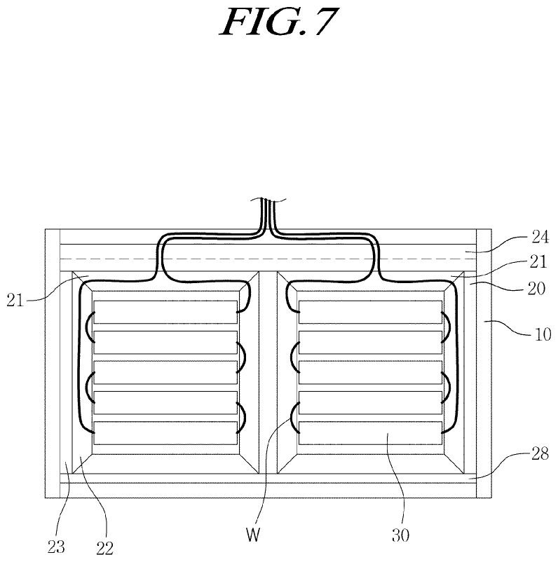

FIG. 7 is a schematic diagram showing an entire form of wire in the present invention. Considering an inverter voltage of several tens of volts V, a plurality of solar panels 30 generating a voltage of several volts V must be connected in series by an electric wire W. And both ends of the series-connected electric wire W must be connected to an external device. Due to a nature of the project frame 20 which is operated in a project type, as the distance between the project frame 20 and the window frame 10 increases, the wiring of the electric wire W becomes more difficult, and the electric wire W may be caught between the window frame 10 and the project frame 20. Therefore, in a configuration of the present invention, it would be preferable that the electric wire W is connected to the external device through the hinge bar 24, which is at a point that the project frame 20 rotates with respect to the window frame 10. In the same principle, it would be preferable to arrange the electric wire W in the center of the upper cover 21, which is the portion with the least displacement in the upper cover 21 having displacement in the azimuth direction with respect to the longitudinal axis.

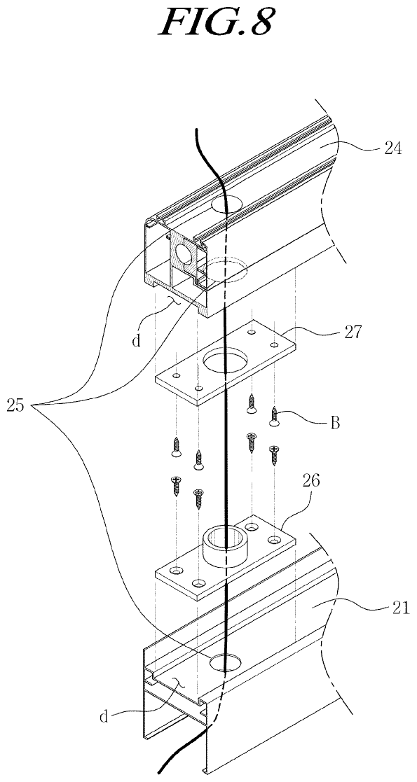

FIG. 8 is an exploded perspective view of part B of FIG. 5. In consideration of the above, a wire hole 25 is formed in the center of the upper cover 21, and the wire hole 25 is also formed in a position corresponding to the hinge bar 24. Since the upper cover 21, the first side cover 22, and the lower cover must be rotated in the azimuth direction, a connecting shaft 26 with hollow is coupled to the upper area of the upper cover 21 and is inserted into the wire hole 25 of the hinge bar 24. And, the electric wire W passes through the hinge bar 24 via the hollow of the connecting shaft 26 and is connected to the external device. In order to save raw materials during extrusion molding, it is preferable that a recessed portion d is formed in the upper cover 21 and the hinge bar 24, and the connecting shaft 26 is coupled to the reinforcing plate 27 by being inserted into the recessed portion d. Since the recessed portion d is formed in the upper cover 21 and the hinge bar 24 to an extent to the thickness and width of the connecting shaft 26 and the reinforcing plate 27, and the connecting shaft 26 is coupled to the reinforcing plate 27 in the recessed portion d. it is possible to reduce the raw materials required for manufacturing the upper cover 21 and the hinge bar 24 while maintaining the mechanical strength.

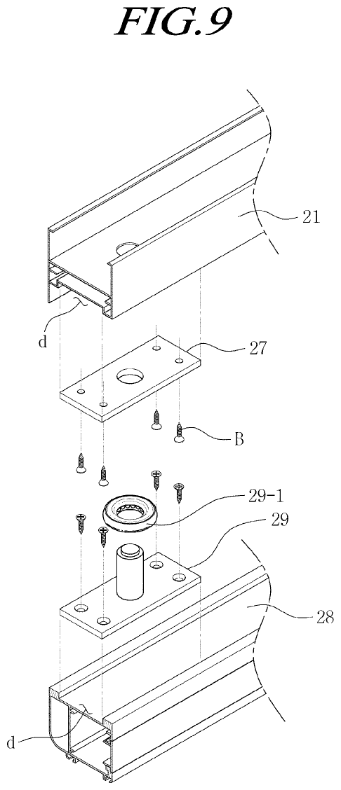

FIG. 9 shows a lower portion of the project frame 20 rotated in the azimuth direction. Similar to the upper portion of the project frame 20, the recessed portion d is formed in the first lower cover 21 and the second lower cover 28. A rotating shaft 29 formed in the recessed portion d of the second lower cover 28 is inserted into the first lower cover 21. At this time, the reinforcing plate 27 may be provided in the recessed portion d of the first lower cover 21, and the solar panel 30 may be smoothly rotated in an azimuth direction due to a bearing 29-1 provided between the reinforcing plate 27 and the rotating shaft 29.

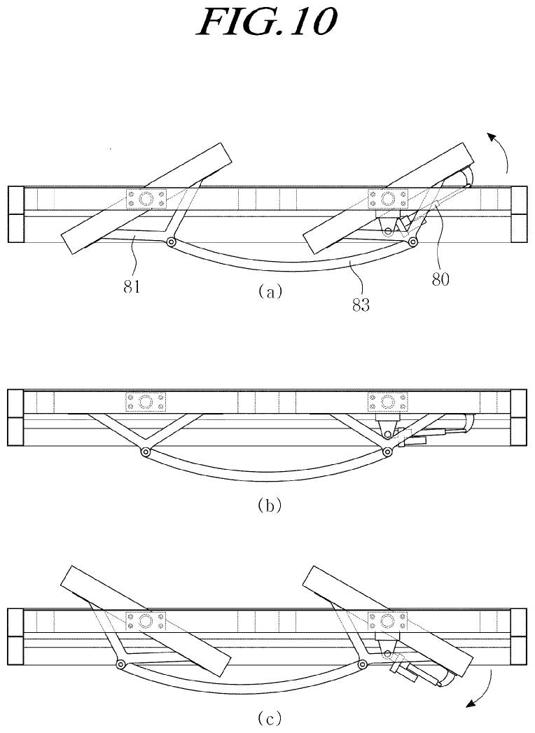

FIG. 10 is an operating state diagram of another embodiment of a project type solar window system with a fall protector according to the present invention. It reduces the number of azimuth control cylinders 80 in the system shown in FIG. 5. Two or more solar panels 30 are coupled to the ‘V’-shaped supporting bar 81 and the ‘V’-shaped supporting bar 81 is connected to the arc-shaped supporting bar 83. Then, if one solar panel 30 is rotated by the azimuth control cylinder 80, the azimuth of two or more solar panels 30 may be changed. At this time, the reason for connecting the ‘V’-shaped supporting bar 81 to the arc-shaped supporting bar 83 is that the solar panel 30 may avoid interference with the arc-shaped supporting bar 83 when the solar panel 30 rotates in the azimuth direction as shown in FIG. 10C.

Although the embodiments of the present specification have been described in more detail with reference to the accompanying drawings, the present specification is not necessarily limited to these embodiments, and various modifications may be made within the scope without departing from the technical spirit of the present specification. Accordingly, the embodiments disclosed in the present specification are for explaining rather than limiting the technical spirit of the present specification, and the scope of the technical spirit of the present specification is not limited by these embodiments. Therefore, it should be understood that the embodiments described above are illustrative in all respects and not restrictive. The protection scope of the present specification should be construed by the claims, and all technical ideas within the scope equivalent thereto should be construed as being included in the scope of the present specification.

### Explanation of Quotation Mark

10 Window frame 11 Threshold
20 Project frame 21 Upper cover
22 First side cover 23 Second side cover
24 Hinge bar 25 Wire hole
26 Connecting shaft 27 Reinforcing plate
28 Second lower cover 29 Rotating shaft
29-1 Bearing 30 Solar panel
40 Project cylinder 50 Tilt cylinder
60 Fall protecting chassis 61 Fall protecting rib
63 Accepting hole 70 Support
71 Supporting rib 73 Slide bar
75 Guide slit

### CROSS-REFERENCE TO RELATED APPLICATION

The instant patent application claims priority under 35 U.S.C. 119(a) to Korean Patent Application No. 10-2021-0077996, filed on Jun. 16, 2021, in the Korean Intellectual Property Office, the disclosure of which is herein incorporated by reference in its entirety. The present patent application claims priority to other applications to be filed in other countries, the disclosures of which are also incorporated by reference herein in their entireties.

1. A project type solar window system with fall protector, comprising:
a window frame;
a project frame with an upper end hinged to an upper end of the window frame configured to be opened and closed in a project type with respect to the window frame;
a solar panel provided inside the project frame;
a project cylinder installed between the window frame and the project frame that allows the project frame to be opened and closed in a project type with respect to the window frame;
a tilt cylinder installed on the project frame that allows the solar panel to be opened and closed by tilting with respect to the project frame; and
a fall protecting chassis installed at rear end of the window frame.

2. The project type solar window system with fall protector of claim 1, wherein an accepting hole is formed to accept the project cylinder in a leftmost and a rightmost side fall protecting ribs of the fall protecting chassis.

3. The project type solar window system with fall protector of claim 1, wherein the project frame includes an upper cover, a first side cover, a lower cover, a second side cover which is opened and closed in a project type in the outside of the first side cover, and a hinge bar coupled on the upper cover to enable the second side cover to rotate in a project type that form a quadrangular frame to embed the solar panel inside;
a wire hole is formed in the center of the upper cover and the hinge bar;
a connecting shaft with hollow is coupled to an upper area of the upper cover and is inserted into the wire hole of the hinge bar; and
an electric wire passes through the hinge bar via the hollow of the connecting shaft and is connected to an external device.
